(19) United States
(12) Patent Application Publication
(10) Pub. No.: US 2004/0202234 A1
(43) Pub. Date: Oct. 14, 2004

(54) Low-complexity and fast frequency offset estimation for OFDM signals

(75) Inventor: Zhongjun Wang, Singapore (SG)

Correspondence Address: SUGHRUE MION, PLLC, 2100 Pennsylvania Avenue, NW, Washington, DC, 20037-3213, US

(73) Assignee: AGENCY FOR SCIENCE, TECHNOLOGY AND RESEARCH

(21) Appl. No.: 10/411,211

(22) Filed: Apr. 11, 2003

(51) Int. Cl. H04B 1/707

(52) U.S. Cl. 375/149; 375/150

(57) ABSTRACT

A receiver is to be synchronized to a transmitter. Two short symbols are sampled in a signal received from the transmitter. The correlation between the two short symbols is determined. The coarse carrier frequency offset of the signal is estimated based on the correlation between the two short symbols. Rather than calculating the phase angle of the correlation between the short symbols, the coarse carrier frequency offset of the signal is determined by dividing the numerical interval of the phase angle of the correlation between the samples of the short symbol into certain equal portions from which their middle values are respectively chosen. Two long symbols in the signal relatively longer in time than the two short symbols are also sampled. The correlation between the two long symbols is determined. A fine carrier frequency offset of the signal is estimated based on the correlation between the two long symbols. A final carrier frequency offset of the received signal is then estimated by combining the estimated coarse and fine carrier frequency offsets prior to correcting the carrier frequency offset of the received signal. The estimated coarse and fine carrier frequency offsets are combined together by adding a multiple of the spacing between carriers forming the signal to the estimated fine carrier frequency offset. The carrier frequency offset of the received signal is corrected using the final carrier frequency offset to synchronize the receiver to the transmitter.

### FIELD OF THE INVENTION

The present invention relates to a method for carrier frequency offset (CFO) estimation. More particularly, the invention relates to CFO estimation in Orthogonal Frequency Division Multiplexing (OFDM) communications systems.

### BACKGROUND OF THE INVENTION

OFDM signals are generated by dividing a high-rate information stream into a number of lower rate streams that are transmitted simultaneously over a number of subcarriers. In an OFDM based communication system, the intersymbol interference (ISI) can be simply eliminated by appending a cyclic prefix, commonly referred to as a guard interval (GI), at the beginning of each OFDM symbol. When compared to a single carrier system, the OFDM system is advantageous to achieving high-speed digital transmission over frequency-selective fading channels. However, the OFDM system is known to be sensitive to the inter-carrier interference which, in a 5 GHz wireless LAN, is mainly due to the carrier frequency offset (CFO) caused by oscillator instabilities of both transmitter and receiver. A scheme for CFO estimation and compensation should be employed and the residual CFO should be kept within a small fraction of the subcarrier spacing to achieve negligible performance degradations—i.e., to maintain required bit error rate and packet error rate. In this context the IEEE 802.11a WLAN standard intends to use two out of ten short OFDM symbols 11 and two long OFDM symbols 13 in the packet preamble 15 for CFO estimations, as shown in FIG. 1 (see also FIG. 110 of “WLAN MAC and PHY Specification: High-speed Physical Layer in the 5 GHz Band”, IEEE Std 802.11a Supplement to IEEE Std Part 11, Sept. 1999).

Several CFO estimation algorithms, which are generally based on correlation of some repeated OFDM symbols, have been developed. The two commonly cited simple yet effective techniques in this area are the frequency-domain maximum likelihood estimation (MLE) algorithm proposed by Moose (P. Moose, “A technique for orthogonal frequency division multiplexing frequency offset correction”, IEEE Trans. Commun., vol. 42, no. 10, pp. 2908-2914, Oct. 1994) and the time-domain correlation algorithm provided by Schmidl et al. (T. M. Schmidl and D. C. Cox, “Robust frequency and timing synchronization for OFDM,” IEEE Trans. Commun., vol. 45, no. 12, pp. 1613-1621, Dec. 1997). When applied in the IEEE 802.11a WLANs, the algorithm in the Moose reference can achieve a fine estimation of CFO with sufficient accuracy based on the observation of two identical and consecutively received long OFDM symbols. However, the maximum estimable offset in this case is limited within half the subcarrier spacing, which is less than the maximum permissible frequency offset in the 5 GHz WLANs. The estimation range can be widened by using two shorter symbols to perform a coarse estimation, at the price of lower accuracy. In practice, an integrated estimation which combines the advantages of both coarse and fine estimations is thus desirable. This invention provides such a solution based on a very low-complexity architecture.

Following the techniques in the Moose and the Schmidl et al. references, the coarse and fine estimates of CFO are given by:

$$\begin{matrix}Δ {f}_{S} = \frac{2 {f}_{CS}}{π} arg ( {ϕ}_{S} ) , with {ϕ}_{S} = {\sum }_{k = - {K}_{S}}^{{K}_{S}} [ {Y}_{2 k}^{S} \cdot {Y}_{1 k}^{{S}^{*}} ] , & ( 1 ) \\ and & \\ Δ {f}_{L} = \frac{{f}_{CS}}{2 π} arg ( {ϕ}_{L} ) , with {ϕ}_{L} = {\sum }_{k = - {K}_{L}}^{{K}_{L}} [ {Y}_{2 k}^{L} \cdot {Y}_{1 k}^{{L}^{*}} ] , & ( 2 )\end{matrix}$$

respectively, where f_{cs} is the subcarrier spacing, (·)* denotes the complex conjugate, and arg(·) stands for the argument operation. Y^{S}₁ₖ and Y^{S}₂ₖ are the complex samples of two successive short symbols, and, correspondingly, Y^{L}₁ₖ and Y^{L}₂ₖ are for two long symbols. Thus φ_{S} and φ_{L} represent the correlation between the samples. These samples can either have time-domain values or frequency-domain values (after the FFT demodulation), depending on which of the above two algorithms in the Moose and the Schmidl et al. references is used. Obviously, the coarse estimation can deal with a maximum CFO four times larger than the fine estimation, while the latter can provide much better accuracy due to more samples (K_{L}>K_{S}) used for the estimation.

Equations (1) and (2) imply maximum estimable CFOs of ±2f_{cs} and ±0.5f_{cs}, respectively. In actual implementation, the coarse estimation can be explicitly obtained as,

$$\begin{matrix}Δ {f}_{S} = \frac{2 {f}_{cs}}{π} \{ {tan}^{- 1} [ \frac{Im ( {ϕ}_{S} )}{Re ( {ϕ}_{S} )} ] + ρ \cdot π \} , \\ ρ = \{ \begin{matrix}0 , & if sgn [ Re ( {ϕ}_{S} ) ] = 1 ; \\ sgn [ Im ( {ϕ}_{S} ) ] , & otherwise .\end{matrix}\end{matrix} \qquad ( 3 )$$

Here, sgn(x) denotes the sign of value x. The operation

$$( {tan}^{- 1} [ \frac{Im ( {ϕ}_{S} )}{Re ( {ϕ}_{S} )} ] + ρ \cdot π )$$

provides the phase angle of the correlation between the samples of the short symbols. A similar expansion can be obtained for Δf_{L} as,

$$\begin{matrix}Δ {f}_{L} = \frac{{f}_{cs}}{2 π} \{ {tan}^{- 1} [ \frac{Im ( {ϕ}_{L} )}{Re ( {ϕ}_{L} )} ] + ρ \cdot π \} , \\ ρ = \{ \begin{matrix}0 , & if sgn [ Re ( {ϕ}_{L} ) ] = 1 ; \\ sgn [ Im ( {ϕ}_{L} ) ] , & otherwise .\end{matrix}\end{matrix} \qquad ( 4 )$$

Given f_{cs}=312.5 KHz in the IEEE 802.11a WLAN, the fine and coarse estimations will be valid only when the actual CFO is within ±156.25 KHz (±0.5f_{cs}) and ±625 KHz (±2f_{cs}) respectively. However, the local center frequency tolerance in this case is defined to be ±20 ppm maximum, which leads to a CFO of ±40 ppm in the worst case (see the WLAN MAC and PHY Specification reference cited above). This translates to a maximum CFO of ±232.2 KHz for the channel with the highest frequency of 5.805 GHz, which is within the estimable range of the coarse estimation but exceeds the range limit of the fine estimation.

It should also be noted that, due to noise and the discontinuity of tan⁻¹, the estimation becomes unreliable when the actual CFO is close to the estimation boundaries. The estimation may swing from the positive end to the negative end and vice versa. This wrapping phenomenon has been mentioned in the Moose reference and is further demonstrated here through simulations as shown in FIG. 2.

One solution to the above problems is an integrated estimation with a coarse estimation—partial compensation—fine estimation architecture. In this joint estimation, any true CFO Δf which is within the range of ±2Δf_{cs}, will be first estimated as Δf₁ by the coarse estimation process. The estimation Δf₁ may not be very accurate, but is accurate enough for being used to compensate the CFO in the following two long symbols to some extent so that the residual offset, Δf−Δf₁, involved in the partially CFO compensated long symbols is surely within the range of 0.5f_{cs}. This means that the wrapping phenomenon at the estimation boundaries may never happen when using these two partially compensated long symbols to perform the fine estimation, which results in an estimated offset of Δf₂. By this procedure, the final estimation, Δf₁+Δf₂, which is used to correct the following data symbols, enjoys the wide acquisition range of the coarse-estimation, ±2Δf_{cs} (±625 KHz), and the high accuracy of the fine-estimation.

When actually implemented, the above architecture needs to calculate the tan¹( ) function twice, once for the coarse estimation, and again for the fine-estimation. Such trigonometric computations usually take many clock cycles for processing. In addition, when the algorithm in the Moose reference is used for fine estimation, the intermediate sample-by-sample CFO compensation for two long symbols using the estimation Δf₁ introduces extra computations and requires large amounts of storage. In this case, computations of at least 128 different cosine and sine values, plus 128 complex products, are required. This is highly undesirable in an application where an efficient implementation with low complexity, low power and fast processing is expected.

An alternative way to achieve an integrated CFO estimation is proposed in the above cited reference by Schmidl et al., as well as another reference by Schmidl et al. (T. M. Schmidl and D. C. Cox, “Timing and frequency synchronization of OFDM signals”, U.S. Pat., Pat. No.: 5,732,113, May 24, 1998). The basic idea is to find the fractional part of CFO (fine estimation) first, and then partially correct the CFO using the fractional estimation, followed by searching the integer part of the CFO in the frequency domain (coarse estimation). It should be noted that, here, both fine and coarse estimation need to use two long training symbols which are immediately followed by actual information OFDM symbols in a WLAN data packet. Since the search of integer part of CFO is a type of iterative process which involves considerable computations, it may take some time and cause undesirable delay problems when actually implemented.

Some other techniques have also been investigated but with structures that are much more complicated than the present invention. These techniques are described in more detail in the following references: J. Li, G. Liu, and G. B. Giannakis, “Carrier frequency offset estimation for OFDM-based WLANs,” IEEE Signal Processing Letters, vol. 8, no. 3, pp. 80-82, Mar. 2001; M. Morelli and U. Mengali, “An improved frequency offset estimator for OFDM applications,” IEEE Commun. Lett., vol. 3, pp. 75-77, Mar. 1999; P. Moose, “Synchronization, channel estimation and pilot tone tracking system”; U.S. Patent Application Publication, Pub. No.:US 2002/0065047 A1, May 30, 2002; J. -W. Cho, Y. -B. Dhong, H. -K. Song, J. -H. Paik, Y. -S. Cho and H. -G. Kim, “Method of estimating carrier frequency offset in an orthogonal frequency division multiplexing system”, US Patent No.: 6,414,936, Jul. 2, 2002; and H. -K. Song, Y. -H. You, J. -H. Paik; and Y. -S. Cho “Frequency-offset synchronization and channel estimation for OFDM-based transmission,” IEEE Commun. Lett., vol. 4, pp. 95-97, Mar. 2000.

It would be desirable to provide a simple method for removing the “wrapping phenomena” at the boundaries of the fine CFO estimate and accurately estimating CFO over a broad range. In addition, it would be desirable to provide a faster and more efficient CFO estimation.

### SUMMARY OF THE INVENTION

The present invention, unlike the prior art, provides a very simple architecture with greatly simplified coarse CFO estimation. In addition, the present invention eliminates the “wrapping phenomena” at the boundaries of the fine CFO estimate.

In general terms, the present invention includes a method for synchronizing a receiver to a transmitter. Two short symbols are sampled in a signal received from the transmitter. The correlation between the two short symbols is determined. The coarse carrier frequency offset of the signal is estimated based on the correlation between the two short symbols. Two long symbols in the signal relatively longer in time than the two short symbols are also sampled. The correlation between the two long symbols is determined. A fine carrier frequency offset of the signal is estimated based on the correlation between the two long symbols. A final carrier frequency offset of the received signal is then estimated by combining the estimated coarse and fine carrier frequency offsets prior to correcting the carrier frequency offset of the received signal. The carrier frequency offset of the received signal is corrected using the final carrier frequency offset to synchronize the receiver to the transmitter.

The present invention also includes a communications system comprising a transmitter and a receiver. A sampler samples two short symbols in a signal received from the transmitter. A correlator determines the correlation between the two short symbols. Also included is a means for estimating a coarse carrier frequency offset of the signal based on the correlation between the two short symbols. A second sampler samples two long symbols in the signal which are relatively longer in time than the two short symbols. A second correlator determines the correlation between the two long symbols. Additionally, the invention has a means for estimating a fine carrier frequency offset of the signal based on the correlation between the two long symbols, and a means for estimating a final carrier frequency offset of the received signal by combining the estimated coarse and fine carrier frequency offsets prior to correcting the carrier frequency offset of the received signal. Finally, a means for correcting the carrier frequency offset of the received signal using the final carrier frequency offset synchronizes the receiver to the transmitter.

In both the method and communications system embodying the method, the coarse carrier frequency offset is estimated by dividing the numerical interval of the phase angle of the correlation between the samples of the short symbols into certain equal portions from which their middle values are respectively chosen. Also, the estimated coarse and fine carrier frequency offsets are combined together by adding a multiple of the spacing between carriers forming the signal to the estimated fine carrier frequency offset.

### BRIEF DESCRIPTION OF THE FIGURES

Further preferred features of the invention will now be described for the sake of example only with reference to the following figures, in which:

FIG. 1 shows a representation of the conventional ten short and two long symbols in a packet preamble of an IEEE Std 802.11a OFDM signal used by the present invention for CFO estimation.

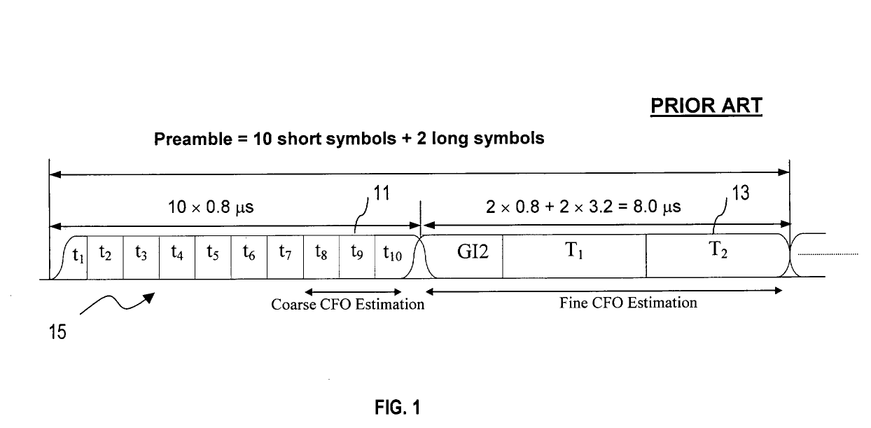

FIG. 2 shows a plot of simulation results of the standard deviation of the estimated CFO versus the actual CFO to illustrate the “wrapping phenomenon” of the prior-art. Close to the estimation boundaries of prior art fine CFO estimation methods, the estimation swings from the positive end to the is negative end and vice versa.

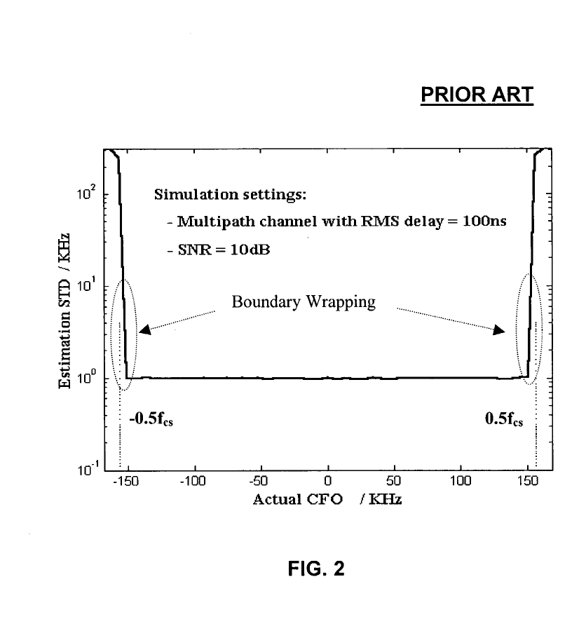

FIG. 3 shows the steps for implementing the CFO estimation of the present invention.

FIG. 4 is a plot of the standard deviation of the estimated CFO versus the actual CFO for both the method of the present invention and the prior art for various signal to noise ratios. The plot illustrates how the present invention provides similar accuracy over the same large acquisition range of ±2f_{cs} as does the prior art joint estimation method.

### DETAILED DESCRIPTION OF THE EMBODIMENTS

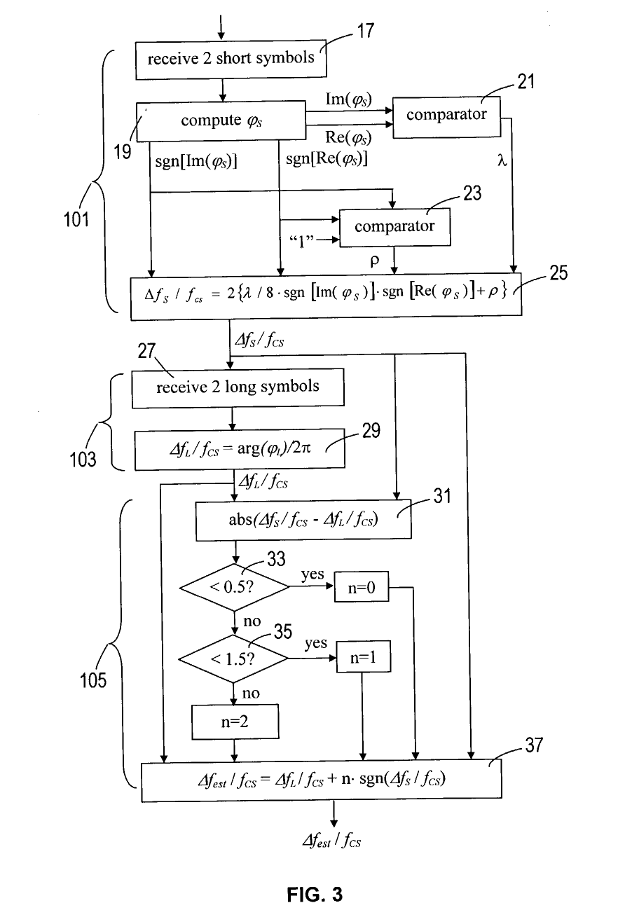

Referring to FIG. 3, the estimation of the CFO consists of three basic steps. First, a coarse estimation 101 using 2 short symbols is performed. Here, instead of using the coarse estimator of equation (3) to obtain Δf_{S}, the present invention uses a much simpler one as shown in the following equation:

$$\begin{matrix}Δ {f}_{S} = 2 {f}_{cs} \{ λ / 8 \cdot sgn [ Im ( {ϕ}_{S} ) ] \cdot sgn [ Re ( {ϕ}_{S} ) ] + ρ \} , with \\ ρ = \{ \begin{matrix}0 , & if sgn [ Re ( {ϕ}_{S} ) ] = 1 ; \\ sgn [ Im ( {ϕ}_{S} ) ] , & otherwise .\end{matrix} \\ and \\ λ = \{ \begin{matrix}3 , & \vert Im ( {ϕ}_{S} ) \vert > \vert Re ( {ϕ}_{S} ) \vert ; \\ 1 , & otherwise .\end{matrix}\end{matrix} \qquad ( 5 )$$

The coarse estimation 101 is implemented by receiving 2 short symbols 11 at step 17. The correlation of samples from the 2 short symbols is computed at step 19 as above by:

$${ϕ}_{S} = {\sum }_{k = - {K}_{S}}^{{K}_{S}} [ {Y}_{2 k}^{S} \cdot {Y}_{1 k}^{{S}^{*}} ]$$

where, as above, Y^{S}₁ₖ and Y^{S}₂ₖ are the complex samples of two successive short symbols. The imaginary and real parts of the correlation of samples from the short symbols Im(φ_{S}) and Re(φ_{S}) are calculated and supplied to a comparator at step 21 to determine λ in the equation (5). Additionally, the signs of Im(φ_{S}) and Re(φ_{S}) are calculated and, together with λ from step 21, are supplied to a short symbol frequency offset determination step 25. The IS signs of Im(φ_{S}) and Re(φ_{S}) are fed into a comparator at step 23 to determine ρ in the equation (5) which is also supplied to step 25. At step 25, the estimated CFO for the short symbols relative to the carrier spacing, Δf_{S}/f_{cs}, is determined according to the equation (5). This method using equation (5) to perform the coarse estimation 101 is much more efficient than the prior-art methods using equation (3) because there is no need to calculate the phase angle of the correlation between the short symbols using

$$( {tan}^{- 1} [ \frac{Im ( {ϕ}_{S} )}{Re ( {ϕ}_{S} )} ] + ρ \cdot π ) .$$

This saves the computational resources needed to perform a division operation and an inverse tangent operation. Rather, the coarse estimation 101 is performed using the “no-angle-calculation estimation” of equation (5).

Second, following equation (4), the fine estimation 103 using 2 long symbols is performed independently of the coarse estimation. The fine estimation 103 is implemented by receiving 2 long symbols 13 at step 27. As in the prior art, the fine estimate of CFO for the long symbols relative to the carrier spacing, Δf_{L}/f_{cs}, is determined according to the equations (2) or (4) at step 29. The details for implementing the fine estimate of CFO are similar to those disclosed in the prior art.

Finally, the separate estimation results, Δf_{S} and Δf_{L}, are combined together at step 105 by the following equation to determine the estimated CFO Δfₑₛₜ,

Δfₑₛₜ=Γ(Δf_{S},Δf_{L})=Δf_{L}+sgn(Δf_{S})·n·f_{cs}, (6)

where n can be one of values 0, 1, or 2, subject to the validity of

0.25·n(n+1)f_{cs}≦|Δf_{S}−Δf_{L}|<(n+0.5)f_{cs}, (7)

and, if the to-be-estimated CFO is known within ±2f_{cs}.

Step 105 is implemented by inputting the result Δf_{S}/f_{cs} of step 25 along with the result Δf_{L}/f_{cs} of step 29 into a step 31 which determines the absolute value of the difference of Δf_{S}/f_{cs} and Δf_{L}/f_{cs} as in equation (7). Next comparison steps 33 and 35 are performed to determine the value of n in equation (6) using the method of equation (7). The results from steps 25 and 29, along with the determined value of n is fed into a step 37 implementing equation (6). Step 37 outputs the estimated CFO relative to the carrier frequency spacing Δfₑₛₜ/Δf_{cs}.

The principal behind equation (5) is to divide the numerical interval [−π/2, π/2] of the tan⁻¹(·) function into 4 equal portions, with each represented by its middle value, i.e., {−3π/8, −π/8, π/8, 3π/8}. Since tan(±π/4)=±1, the division Im(φ_{S})/Re(φ_{S}) in (3) is no longer required. This technique also successfully removes the wrapping effect at the boundaries of fine estimation. If the actual CFO is (0.5 f_{cs}−δ₁), for example, the result from the fine estimation may swing to Δf_{L}=(−0.5 f_{cs}+δ₂). Here, δ₁ and δ₂ are very small positive values. In this case, from (5), Δf_{S} will be given a value either of 0.25 f_{cs} or 0.75 f_{cs}. When applied to (6) and (7), the result is that n=1 and Δfₑₛₜ=0.5 f_{cs}+δ₂, which still closely approximates the actual CFO.

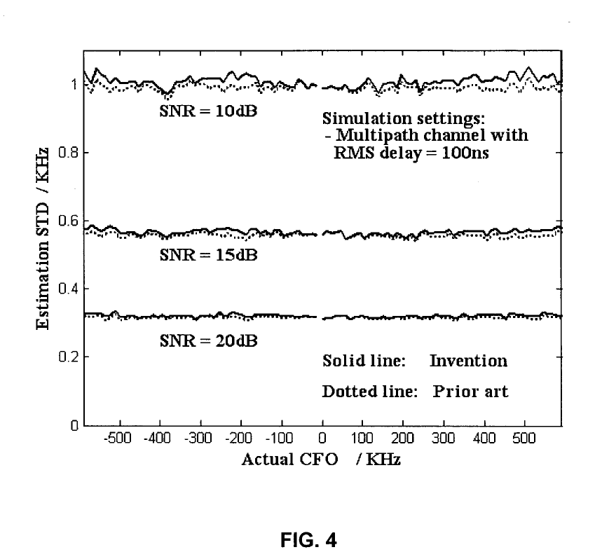

It can be seen that, with a very low-complexity architecture and fast processing, the present invention can achieve the similar high estimation accuracy with same large acquisition range of ±2 f_{cs} as that of the normal joint estimation, as shown in FIG. 4. Considerable reduction of computations is achieved by the present invention, because no angle-calculation of tan⁻¹(·) is required for the coarse estimation and little complexity is added by implementing Γ(Δf_{S}, Δf_{L}). In particular, if the time-domain correlation algorithm in the reference “Robust frequency and timing synchronization for OFDM” by Schmidl et al. is chosen for computing φ_{S}, the total implementation complexity for coarse estimation in the present invention becomes negligible because the values Im(φ_{S}) and Re(φ_{S}) are usually already there for use after the pre-executed timing synchronization process and the rest of the operations require minimal processing. Thus, the total complexity of the scheme mainly comes from the fine estimation. This means that a fast CFO estimation scheme with large acquisition range and high accuracy only requires the implementation complexity equivalent to that of a single fine CFO estimation. Therefore, the present invention provides the simplest among all known schemes for achieving similar performance.

Although the invention has been described above using particular embodiments, many variations are possible within the scope of the claims, as will be clear to a skilled reader. For example, the flow shown in FIG. 3 for implementing the equations (5) to (7) may be optimized in conformance to the actual system requirements so that the overall system becomes the simplest while its performance is not degraded.

We claim:

1. A method for synchronizing a receiver to a transmitter comprising the steps of:
sampling two short symbols in a signal received from the transmitter;
determining the correlation between the two short symbols;
estimating a coarse carrier frequency offset of the signal based on the correlation between the two short symbols;
sampling two long symbols in the signal relatively longer in time than the two short symbols;
determining the correlation between the two long symbols;
estimating a fine carrier frequency offset of the signal based on the correlation between the two long symbols;
estimating a final carrier frequency offset of the received signal by combining the estimated coarse and fine carrier frequency offsets prior to correcting the carrier frequency offset of the received signal; and
correcting the carrier frequency offset of the received signal using the final carrier frequency offset to synchronize the receiver to the transmitter.

2. The method of claim 1 wherein the estimation of the coarse carrier frequency offset of the signal is performed by performing a no-angle-calculation using the correlation between the two short symbols.

3. The method of claim 1, wherein the estimation of the coarse carrier frequency offset is achieved by dividing the numerical interval of the phase angle of the correlation between the samples of the short symbol into certain equal portions from which their middle values are chosen.

4. The method of claim 1, wherein the coarse carrier frequency offset Δf_{S} is estimated from:
Δf_{S}=2f_{cs}{λ/8·sgn[Im(φ_{S})]·sgn[Re(φ_{S})]+ρ}
where:
f_{cs} is the carrier spacing between carriers of the signal;
φ_{S} is the correlation between the samples taken from the short symbols;
$$ρ = \{ \begin{matrix}0 , & if sgn [ Re ( {ϕ}_{S} ) ] = 1 ; \\ sgn [ Im ( {ϕ}_{S} ) ] , & otherwise .\end{matrix}$$
and
$$λ = \{ \begin{matrix}3 , & \vert Im ( {ϕ}_{S} ) \vert > \vert Re ( {ϕ}_{S} ) \vert ; \\ 1 , & otherwise .\end{matrix} .$$

5. The method of claim 1, wherein the fine carrier frequency offset Δf_{L} is estimated from:
$$Δ {f}_{L} = \frac{{f}_{cs}}{2 π} \{ {tan}^{- 1} [ \frac{Im ( {ϕ}_{L} )}{Re ( {ϕ}_{L} )} ] + ρ \cdot π \}$$
where:
f_{cs} is the carrier spacing between carriers of the signal;
φ_{L} is the correlation between samples taken from the long symbols;
and
$$ρ = \{ \begin{matrix}0 , & if sgn [ Re ( {ϕ}_{L} ) ] = 1 ; \\ sgn [ Im ( {ϕ}_{L} ) ] , & otherwise .\end{matrix} .$$

6. The method of claim 1, wherein the estimated coarse and fine carrier frequency offsets are combined together by adding a multiple of the spacing between carriers forming the signal to the estimated fine carrier frequency offset.

7. The method of claim 1, wherein the estimated coarse carrier frequency offset Δf_{S} and fine carrier frequency offset Δf_{L} are combined together to obtain the final carrier frequency offset Δfₑₛₜ according to:
Δfₑₛₜ=Δf_{L}+sgn(Δf_{S})·n·f_{cs},
where
f_{cs} is the carrier spacing between carriers of the signal; and where n is one of values 0, 1, or 2, subject to the validity of
0.25·n(n+1)f_{cs}≦|Δf_{S}−Δf_{L}|<(n+0.5)f_{cs}.

8. The method of claim 1 wherein the signal is an OFDM signal.

9. The method of claim 1 wherein the long symbols are four times longer than the short symbols.

10. The method of claim 1, wherein the short symbols and long symbols are part of an OFDM preamble.

11. A communications system comprising:
a transmitter;
a receiver;
a sampler for sampling two short symbols in a signal received from the transmitter;
a correlator for determining the correlation between the two short symbols;
a means for estimating a coarse carrier frequency offset of the signal based on the correlation between the two short symbols;
a second sampler for sampling two long symbols in the signal relatively longer in time than the two short symbols;
a second correlator for determining the correlation between the two long symbols;
a means for estimating a fine carrier frequency offset of the signal based on the correlation between the two long symbols;
a means for estimating a final carrier frequency offset of the received signal by combining the estimated coarse and fine carrier frequency offsets prior to correcting the carrier frequency offset of the received signal; and
a means for correcting the carrier frequency offset of the received signal using the final carrier frequency offset to synchronize the receiver to the transmitter.

12. The system of claim 11, wherein the estimation of the coarse carrier frequency offset of the signal is performed by performing a no-angle-calculation using the correlation between the two short symbols.

13. The system of claim 11, wherein the estimation of the coarse carrier frequency offset is achieved by dividing the numerical interval of the phase angle of the correlation between the samples of the short symbol into certain equal portions from which their middle values are chosen.

14. The system of claim 11, wherein the coarse carrier frequency offset Δf_{S} is estimated from:
Δf_{S}=2f_{cs}{λ/8·sgn[Im(φ_{S})]·sgn[Re(φ_{S})]+ρ}
where:
f_{cs} is the carrier spacing between carriers of the signal;
φ_{S} is the correlation between the samples taken from the short symbols;
$$ρ = \{ \begin{matrix}0 , & if sgn [ Re ( {ϕ}_{S} ) ] = 1 ; \\ sgn [ Im ( {ϕ}_{S} ) ] , & otherwise .\end{matrix}$$
and
$$λ = \{ \begin{matrix}3 , & \vert Im ( {ϕ}_{S} ) \vert > \vert Re ( {ϕ}_{S} ) \vert ; \\ 1 , & otherwise .\end{matrix} .$$

15. The system of claim 11, wherein the fine carrier frequency offset Δf_{L} is estimated from:
$$Δ {f}_{L} = \frac{{f}_{cs}}{2 π} \{ {tan}^{- 1} [ \frac{Im ( {ϕ}_{L} )}{Re ( {ϕ}_{L} )} ] + ρ \cdot π \}$$
where:
f_{cs} is the carrier spacing between carriers of the signal;
φ_{L} is the correlation between samples taken from the long symbols;
and
$$ρ = \{ \begin{matrix}0 , & if sgn [ Re ( {ϕ}_{L} ) ] = 1 ; \\ sgn [ Im ( {ϕ}_{L} ) ] , & otherwise .\end{matrix} .$$

16. The system of claim 11, wherein the estimated coarse and fine carrier frequency offsets are combined together by adding a multiple of the spacing between carriers forming the signal to the estimated fine carrier frequency offset.

17. The method of claim 11, wherein the estimated coarse carrier frequency offset Δf_{S} and fine carrier frequency offset Δf_{L} are combined together to obtain the final carrier frequency offset Δfₑₛₜ according to:
Δfₑₛₜ=Δf_{L}+sgn(Δf_{S})·n·f_{cs},
where
f_{cs} is the carrier spacing between carriers of the signal; and where n is one of values 0, 1, or 2, subject to the validity of
0.25·n(n+1)f_{cs}≦|Δf_{S}−Δf_{L}|<(n+0.5)f_{cs}.

18. The system of claim 11 wherein the signal is an OFDM signal.

19. The system of claim 11 wherein the long symbols are four times longer than the short symbols.

20. The system of claim 11, wherein the short symbols and long symbols are part of an OFDM preamble.
